(19) United States
(12) Patent Application Publication
(10) Pub. No.: US 2013/0015923 A1
(43) Pub. Date: Jan. 17, 2013

(54) AUTOMATIC WAVEGUIDE SWITCH-BASED PROTECTION SYSTEMS FOR RECEIVER CIRCUITRY

(71) Applicants: WILLIAM MCKINLEY, CLERMONT, FL (US); FRANK R. SIMS, APOPKA, FL (US); STEVEN G. GRAY, ORLANDO, FL (US)

(72) Inventors: WILLIAM MCKINLEY, CLERMONT, FL (US); FRANK R. SIMS, APOPKA, FL (US); STEVEN G. GRAY, ORLANDO, FL (US)

(73) Assignee: LOCKHEED MARTIN CORPORATION, Bethesda, MD (US)

(21) Appl. No.: 13/181,549

(22) Filed: Jul. 13, 2011

(51) Int. Cl. H01P 1/00

(52) U.S. Cl. 333/17.1

(57) ABSTRACT

An automatic protection system for receiver circuitry includes a waveguide switch having a permanent magnet attached to a rotatable manifold and at least one electromagnet axially surrounding the rotatable manifold. An automatic actuation circuit is coupled to the waveguide switch. The automatic actuation circuit includes an RF power detector for detecting incident RF power around the rotatable manifold and generating a detection signal therefrom, a controller coupled to receive the detection signal and for generating at least a first control signal based on the detection signal, and a magnet current driver coupled to receive the first control signal and coupled to the electromagnet. The magnet current driver provides a first drive signal responsive to the first control signal that automatically rotates the rotatable manifold into a protected position that implements a protected path, such as when the incident RF power exceeds a predetermined RF power level.

### FIELD

Disclosed embodiments relate to protection systems including waveguide switches for protecting wireless receiver circuitry.

### BACKGROUND

Electronic circuitry is known to be subject to damage when unintended sources of energy remote from the circuitry become coupled in, such as due to voltage surges and spikes that can couple to power supply lines due to a lightning storm. Lightning protection systems generally work by routing away the voltage surges and spikes travelling along wires from reaching the electrical circuitry it is protecting, and shunting it to ground.

Sources of energy remote to the electronic circuitry can also become coupled in wirelessly to wireless receiver circuitry, such as coupling through their associated antenna. In the case of certain electronic devices on an aircraft, high power levels of radio frequency (RF) radar can damage the electronics, particularly when the receiver electronics are designed to operate in the same RF band as the radar.

One way to protect such electronics from damage from external RF sources, such as RF radar, involves using an actuated switch that mechanically switches between an on/operational position and off/protected position, where an individual (e.g., a pilot of an aircraft) can manually switch the actuator into the off/protected position during intervals of time deemed likely to expose the electronics to potentially damaging external radiation. For example, when landing an aircraft on an aircraft carrier that employs an Auto Carrier Landing System (ACLS) the Ka band landing signals can have enough power to damage the sensitive electronics designed to operate in the same or similar bands, such as the Ka band used by conventional radar seeker circuitry.

### SUMMARY

Disclosed embodiments include automatic protection systems for receiver circuitry comprising a waveguide switch having a permanent magnet attached to a rotatable manifold and at least one electromagnet axially surrounding the rotatable manifold. An automatic actuation circuit is coupled to the waveguide switch. The automatic actuation circuit includes an RF power detector for detecting incident RF power around the rotatable manifold and for generating a detection signal therefrom, and a controller coupled to receive the detection signal for generating at least a first control signal based on the detection signal. The automatic actuation circuit also includes a magnet current driver coupled to receive the first control signal, that is coupled to the electromagnet. The magnet current driver provides a first drive signal responsive to the first control signal that automatically rotates the rotatable manifold into a protected position that implements a protected path, such as when the incident RF power exceeds a predetermined RF power level.

Disclosed waveguide switches provide an interface that provides a switchable connection between an antenna side and a receiver side for at least one, and generally a plurality of waveguide transmission lines referred to herein as “waveguide channels” (sometimes referred to in the art as “waveguide ports”). The connection is generally through a post-switch microstrip probe element for a waveguide to microstrip transition, to one or more instances of receiver circuitry or transceiver circuitry. The waveguide channels each comprise hollow metallic conductors that are commonly used at microwave frequencies, typically to interconnect receivers or transmitters/receivers (transceivers) with antennas. A standard waveguide structure is a hollow metal tube or rectangle that distributes electrical inductance at its walls and capacitance in the space between its walls.

Disclosed embodiments also include protected receiver systems that comprise at least one waveguide channel that extends from an antenna end to a receiver end of the waveguide channel, and at least one antenna for transmitting and receiving RF signals coupled to the antenna end of the waveguide channel. The system includes a disclosed waveguide switch comprising a permanent magnet attached to a rotatable manifold, and at least one electromagnet axially surrounding the rotatable manifold for switchably coupling the antenna end to the receiver end of the waveguide channel. For embodiments having a plurality of waveguides, each waveguide can share one antenna, or in another embodiment each can have their own dedicated antenna.

### BRIEF DESCRIPTION OF THE DRAWINGS

FIG. 1A is a depiction of an example automatic waveguide switch-based protection system for receiver circuitry comprising a waveguide switch and an automatic actuation circuit for actuating the waveguide switch that is positioned to protect receiver circuitry mounted on a printed wiring board (PWB) from damage due to received RF energy, according to an example embodiment.

FIG. 1B is a schematic depiction of an example automatic waveguide switch-based protection system that comprises the waveguide switch and actuation circuit shown in FIG. 1A for protecting receiver circuitry, that further comprises a port termination structure for implementing an enhanced stability mode during the protected state, according to an example embodiment.

FIG. 2A is a depiction of an example automatic waveguide switch-based protection system for receive circuitry comprising a waveguide switch and an automatic actuation circuit positioned to protect receiver circuitry, according to an example embodiment. The top block of the waveguide assembly is shown in phantom to reveal certain otherwise hidden details.

FIG. 2B is a depiction of an example automatic waveguide switch-based protection system for the receive circuitry shown in FIG. 2A with the top block of the waveguide assembly in place.

FIG. 3 is longitudinal section depiction of an example flying vehicle shown as a missile seeker including an RF seeker having RF seeker transceiver electronics protected by a disclosed automatic waveguide switch-based protection system, according to an example embodiment.

### DETAILED DESCRIPTION

Disclosed embodiments are described with reference to the attached figures, wherein like reference numerals, are used throughout the figures to designate similar or equivalent elements. The figures are not drawn to scale and they are provided merely to illustrate aspects disclosed herein. Several disclosed aspects are described below with reference to example applications for illustration. It should be understood that numerous specific details, relationships, and methods are set forth to provide a full understanding of the embodiments disclosed herein. One having ordinary skill in the relevant art, however, will readily recognize that the disclosed embodiments can be practiced without one or more of the specific details or with other methods. In other instances, well-known structures or operations are not shown in detail to avoid obscuring aspects disclosed herein. Disclosed embodiments are not limited by the illustrated ordering of acts or events, as some acts may occur in different orders and/or concurrently with other acts or events. Furthermore, not all illustrated acts or events are required to implement a methodology in accordance with this Disclosure.

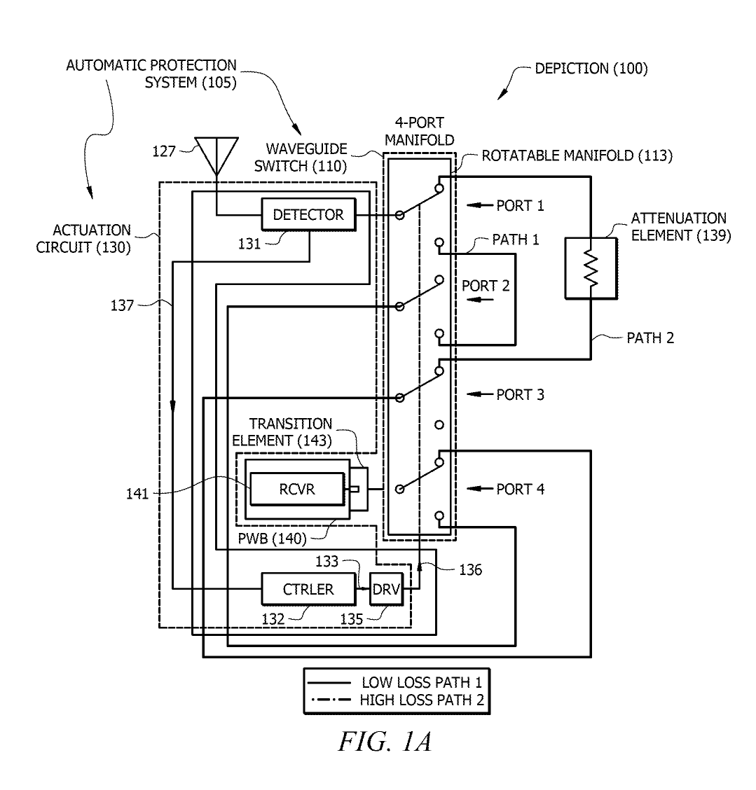

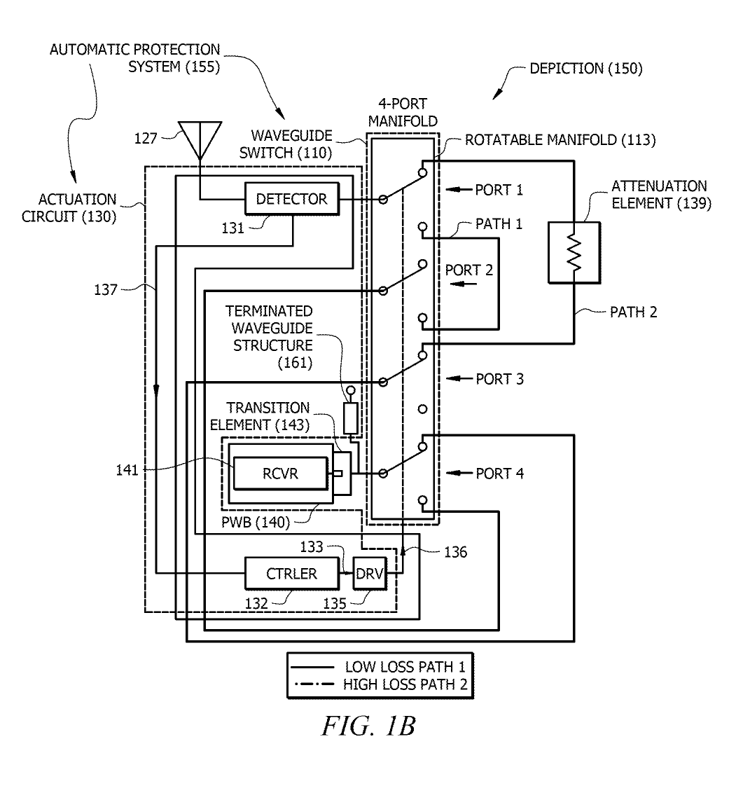

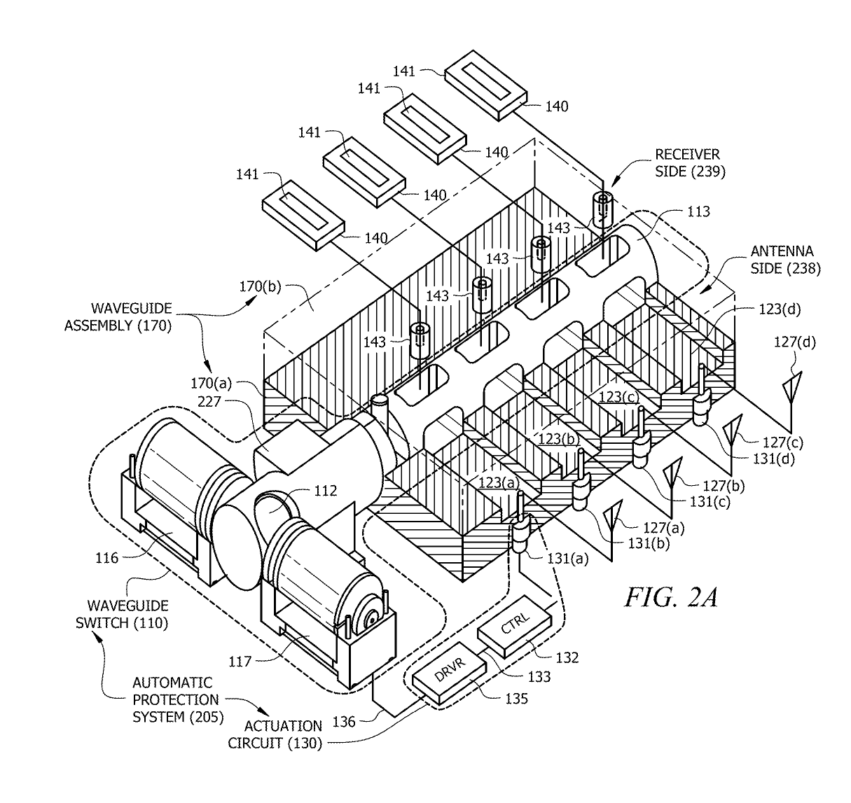

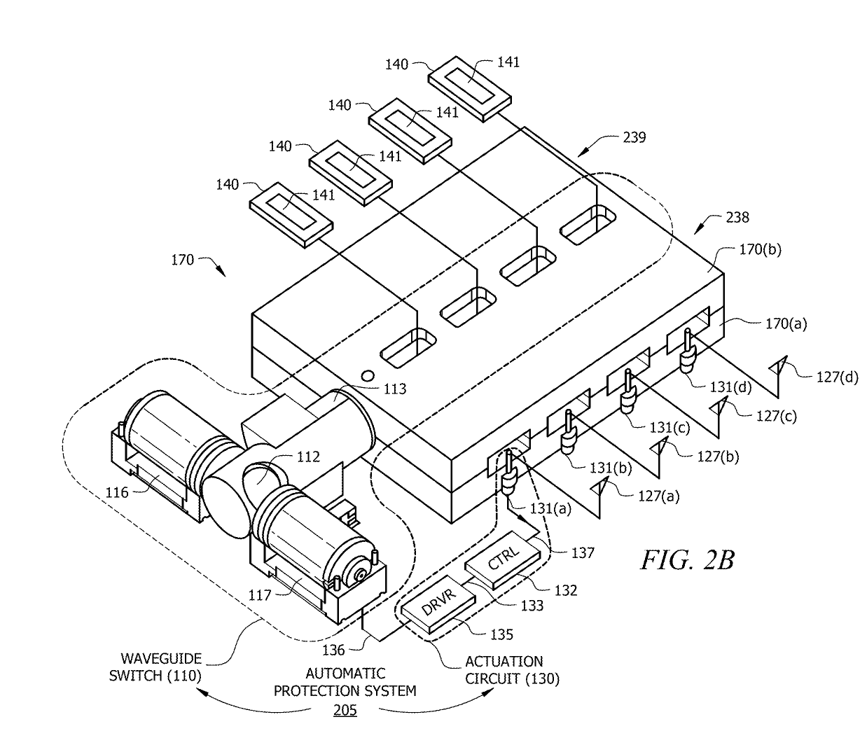

FIG. 1A is a schematic depiction 100 of an example automatic protection system 105 for protecting receive circuitry that comprises a waveguide switch 110 including a 4-port, 2 position rotatable manifold 113 comprising a permanent magnet and at least one electromagnet (see FIG. 2 for example electromagnet/magnet details), and an actuation circuit 130 coupled to the waveguide switch 110 for protecting receiver circuitry 141 shown mounted on a printed wiring board (PWB) 140. Transition element 143 is shown between the waveguide switch 110 and the receiver circuitry 141 for providing a proper transition from the waveguide domain to the microstrip domain. Transition element 143 can provide proper transitioning by comprising an appropriately placed microstrip probe element extending out into the waveguide volume placed about a λ/4 (quarter wavelength) distance to the end of a reflective waveguide back short, where λ is the wavelength of the received radiation. The 4-ports are shown in FIGS. 1A and 1B as Ports 1-4.

A single antenna 127 is shown coupled to detector 131 of the actuation circuit 130. A detection signal 137 from detector 131 is coupled to the controller 132, then to magnet current driver 135, which based on the polarity of the magnet current provide by magnet current driver 135 can determine which of the two positions provided by waveguide switch 110 the waveguide switch is in. In one embodiment the controller 132 comprises a comparator that compares the detection signal 137 to a reference signal (or reference level).

A first position provided by waveguide switch 110 shown as Path 1 is a low loss path that can be used for ordinary operation generally referred to herein as the on/operation state. A second position provided by waveguide switch 110 shown as Path 2 which is shown closed in FIG. 1A is a more highly attenuated (higher loss) path that can be automatically switched in. Path 2 is shown including an attenuator element 139 depicted as a resistor that limits the signal power reaching receiver circuitry 141 to protect the receiver circuitry 141, such as during high energy reception events.

In operation, when output from the detector 131 indicates the power level has dropped sufficiently, such as when the received power drops below a predetermined power threshold, the rotatable manifold 113 can be rotated back into the first position to utilize Path 1 allowing for normal operation. The value of the attenuator element 139 which is in series in Path 2, is generally located inside a length on the receiver side of the waveguide channel that interfaces to waveguide switch 110, that can be selected based on the expected threat level and receiver performance requirement. In one embodiment the value of attenuator element 139 is high enough to effectively provide an open circuit condition for maximum protection.

In another embodiment, the value of the attenuator element 139 for automatic protection system 105 can be selected to implement a protective power reducing bypass mode when Path 2 is activated by rotatable manifold 113, such as if continuous operation is desired while subjected to a high electromagnetic energy (EME) environment. In this embodiment upon detection of a high EME condition, the rotatable manifold 113 can automatically redirect the incident RF energy received by antenna 127 through attenuator element 139 embodied a resistor or impedance element to provide significant attenuation, such as typically a minimum of 20 db (e.g., 20 db, 40 db, or 60 db) to the RF energy received. This added attenuation can reduce the incident RF level to a safe level allowing near normal operation behind a protected level of attenuation.

FIG. 1B is a schematic depiction 150 of an example automatic protection system 155 that comprises the waveguide switch 110 and the actuation circuit 130 shown in FIG. 1A for protecting receiver circuitry 141, that further comprises a termination waveguide structure 161 for implementing an enhanced stability mode during the protected state (Path 2 activated), according to an example embodiment. As the rotatable manifold 113 is switched to the protected state that implements the protected path (Path 2), the antenna 127 sees a change in normal waveguide impedance to a reflection off the short circuit of the rotating manifold's 113 now closed edge. The active electronic devices being protected on the receiver side of the waveguide switch 110 shown as receiver 141 also see this change in input impedance, which can be between an open circuit and a short circuit based upon the waveguide length on the receiver side between the devices such as receiver 141 and the rotatable manifold 113. However, certain active electronic devices are known to need input and/or output impedance matched to provide stability (no oscillation).

Once activated, Path 2 on the receiver side of the rotatable manifold 113 can provide an impedance match by including a terminated waveguide structure 161 that provides a proper termination, such as a waveguide termination. This embodiment helps eliminate or at least reduce receiver device instability upon switching into the protected state.

FIG. 2A is an depiction of an example automatic waveguide switch-based protection system 205 (hereafter “automatic protection system”) comprising waveguide switch 110 and an automatic actuation circuit 130 for actuating the waveguide switch 110 positioned to protect receiver circuitry 141 mounted on a PWB 140 which can be damaged due to excessive RF energy including overvoltage or other potentially damaging conditions coupled in through antennas 127(a)-127(d), according to an example embodiment. Waveguide switch 110 shown in FIG. 2A provides 4 ports, and in one embodiment each port provides a normal low loss on/operation position and an open/protected or high impedance protected position.

The top block 170(b) of the waveguide assembly 170 is shown only in phantom to reveal certain otherwise hidden details, while the bottom block 170(a) is shown conventionally. FIG. 2B is an depiction of the example automatic waveguide switch-based protection system 205 shown in FIG. 2A with the top block 170(b) of the waveguide assembly 170 in place. The waveguide assembly 170 provides four (4) waveguide channels 123(a)-(d) that each include an antenna side 238 and a receiver side 239. Receiver circuitry 141 is coupled to the receiver side 239 of each of the waveguide channels 123(a)-(d), and are switchably coupled by the waveguide switch 110 to the antenna side 238.

A single antenna for multiple waveguide channels, such as for waveguide channels 123(a)-(d), can also be used with disclosed embodiments. While a single physical antenna can be used in monopulse radar, in this case the antenna is electrically separated into 4 sectors or quads (ABCD). These discrete sector antenna outputs are coupled to a “monopulse comparator” that mathematically combines the four pieces of received information to form the SUM, DIFFERENCE, and ELEVATION that lead to target identification. In a dual polarization system (90 degrees phase difference), the single antenna has effectively 8 quads, 8 outputs, producing 2 SUM, 2 DIFFERENCE and 2 ELEVATION results. In this embodiment any one of these eight signals alone could present a signal level that can trigger the protection requirement while each of the others might be at a safe level, so that each waveguide channel 123(a)-(d) as shown in FIGS. 2A and 2B includes its own dedicated RF detector 131(a)-(d), while sharing the same waveguide switch 110. Although only detector 131(a) is shown coupled to controller 132, connections are generally provided between each of the detectors 131(b)-(d) and controller 132.

In one embodiment the waveguide assembly 170 is configured so that the detectors 131(a)-(d) are positioned ¼λ from the rotatable manifold 113, so that the length of the waveguide channels on the antenna side 238 can be about ¼λ. This allows for continuous monitoring of incident power independent of the position of the rotatable manifold without degrading the quality of received signals during the operation during the normal operation state (e.g., Path 1 shown in FIG. 1A).

The waveguide switch 110 includes a permanent magnet 112 mounted on a rotatable manifold 113, and at least one electromagnet shown as a first electromagnet 116 and a second electromagnet 117 axially surrounding the rotatable manifold 113. For example, the permanent magnet 112 can comprise a NdFeB-based magnet. In another embodiment (not shown) the first electromagnet 116 and a second electromagnet 117 can be replaced by a single “C” shaped electromagnet having opposite magnetic poles on either side of the permanent magnet 112. The dual electromagnet approach shown minimizes the volume as compared to closed loop “C” shaped electromagnet configuration to allow fitting into highly spaced limited applications. The waveguide switch 110 provides at least two positions comprising an on/operational position and an off/protected position. In one embodiment the rotatable manifold 113 is mechanically restrained to swing through only 90 degrees during switching, so that a simple bi-directional rotational torque is all that is required to effectuate the movement from one position (0 degrees, e.g., the on/operational position) to the other (90 degrees, e.g., the off/protected position) and back again.

The waveguide switch 110 in FIG. 2A is shown controlling a plurality of waveguides 123(a)-(d) through which signals received by antennas 127(a)-(d) are routed to a waveguide to microstrip probe transition element 143 (hereafter “transition element”) that provides a waveguide to microstrip transition, then to receiver circuitry 141 mounted on the PWB 140. Receiver circuitry 141 can comprise a plurality of integrated circuits (ICs), such as comprising filters, amplifiers and local oscillators (LOs). Although the automatic protection system 205 is shown protecting 4 waveguide channels 123(a)-(d), the number of waveguide channels that can be protected can be from one to several hundred, with a single waveguide switch capable of protecting a plurality of waveguide channels.

While waveguide switch 110 is in the on/operational position, signals received by antenna 127 converted to currents are transmitted by the respective waveguide channels 123(a)-(d) across the rotatable manifold 113 with a low insertion loss to receiver circuitry 141, while in the off/protected position signals received by antenna 127 converted to currents can be blocked from transmission to the receiver side 239 of the respective waveguide channels across the rotatable manifold 113 (off position), or be transmitted with a high insertion loss (e.g., at least 20 db of added attenuation) to receiver circuitry 141 as compared to the insertion loss while in the on/operational position.

In operation of waveguide switch 110, the like, and unlike, polarities associated with the momentarily activated first electromagnet 116 and second electromagnet 117 can leverage the poles of the permanent magnet 112 to neutral/opposing positions thus forcing the rotatable manifold 113 to rotate to the desired stop position. A return rotation can be achieved by reversing the direction of the first drive signal 136 through the coil windings associated with the electromagnets 116, 117. Continuous external power is generally not required to maintain the position of rotatable manifold 113 because the cogging torque (the natural magnetic attraction between the permanent magnet 112 and the magnetic (e.g. iron) core of either of the electromagnet 116, 117) that naturally locks the permanent magnet 112 to the closest metal core associated with its electromagnet 116, 117. Although not shown, a structure for manual override of the position of waveguide switch 110 may be provided, such as for emergency situations (e.g., power outages).

In one particular embodiment, the electromagnets for first electromagnet 116 and second electromagnet 117 can be small, low gauge (e.g., 32 gauge) wire coils wrapped and packaged to form a miniature SMT (surface mount technology) compatible part. This eliminates assembly complexity as these two parts can be placed on a mother PWB assembly with all of the other SMT parts, including receiver circuitry 141. Additionally, the permanent magnet 112 can be selected to have a cylindrical shape and length to minimize any assembly or mounting ambiguities associated with placing it within the manifold shaft, while providing the maximum rotational torque. In operation, the RF power detectors 131(a)-(d) detect instantaneous incident RF power around the rotatable manifold 113 and generate a detection signal 137 therefrom. Each waveguide channel is shown having its own detector. A controller 132 (e.g., microprocessor based) is coupled to receive the detection signal 137 for determining whether potentially dangerous conditions are present such whether the instantaneous RF power has exceeded a predetermined RF power level, or potentially dangerous conditions can be expected to be received imminently, and for generating a control signal 133 based on the determination.

The magnet current driver 135 is coupled to receive the control signal 133 and is coupled to the first electromagnet 116 and second electromagnet 117 for providing a first drive signal 136 that can result in the rotation of the rotatable manifold 113 into the off/protected position during a potentionally damaging condition, such as when the instantaneous incident RF power exceeds the predetermined RF power level, and a second drive signal from driver 135 can automatically rotate the rotatable manifold 113 into the on/operational position wherein when the instantaneous RF power does not exceed the predetermined RF power level. Optional optical position encoder 227 shown in FIG. 2A comprising a receiver and transmitter can be optionally provided for position detecting to determine the instantaneous position of the rotatable manifold 113. The optical position encoder 227 can ensure the desired manifold condition is in effect.

In one embodiment a disclosed automatic waveguide switch-based protection system is used to protect unused ordnance, such as missiles with RF radar seekers returning on an aircraft to an aircraft carrier which can be exposed to extreme levels of Ka-band electromagnetic energy during final approach and landing, such as on an aircraft carrier that employs an ACLS system. The level of RF energy from the ACLS system can damage the sensitive electronics contained within radar seeker assemblies designed to operate in the same (e.g., Ka) band.

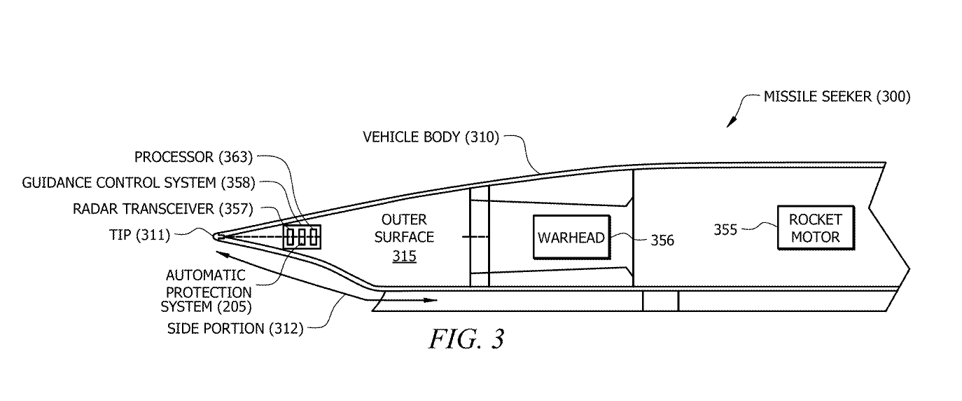

FIG. 3 is longitudinal section depiction of an example flying vehicle shown as a missile seeker 300 comprising an RF seeker having RF seeker transceiver electronics protected by a disclosed automatic waveguide switch-based protection system, according to an example embodiment. The RF seeker system comprises an RF transceiver 357 that generally includes transmitter pulser electronics, and an automatic protection system 205 described above is coupled to protect the electronics associated with RF transceiver 357.

As described above, automatic protection system 205 can be used as an on/off waveguide switch to provide selectivity between two discrete positional states including a normal operational “closed” through path state for normal radar operation, and a protected “open” reflective state used for a safe/protected landing. In one embodiment, as described above, the respective states are 90 degrees apart provided by actuating a ¼ (90 degrees) turn rotation of a rotatable manifold 113 that provides selectable protection, or path steering, for the sensitive internal RF electronics associated with RF transceiver 357 typically associated with radar transceivers. Because selectivity between states is generally required only briefly, such as at the beginning and the end of an operational mission, the high current momentary impulse power requirement to power the automatic protection system 205 can be sourced from the same power supply (not shown) used to power the transceivers transmitter pulser electronics.

The missile seeker 300 comprises a vehicle body 310 having an outer surface 315 including a front portion which includes a tip 311 and a side portion 312. An antenna (not shown) can be positioned near tip 311.

Missile seeker 300 is shown including a rocket motor 355 and a warhead 356. Guidance control system 358 can implement a radar-based homing guidance system. Embodied as an active homing system, target illumination is supplied by a component carried in the missile seeker 300, such as the transceiver electronics 357 shown. The radar signals transmitted from the missile seeker 300 by transceiver electronics 357 are reflected off the target back to the transceiver. These reflected signals give the missile seeker 300 information such as the target's distance and speed. This information allows the guidance control system 358 which includes processor 363 to compute the correct angle of attack to intercept the target.

While various disclosed embodiments have been described above, it should be understood that they have been presented by way of example only, and not as a limitation. Numerous changes to the disclosed embodiments can be made in accordance with the Disclosure herein without departing from the spirit or scope of this Disclosure. Thus, the breadth and scope of this Disclosure should not be limited by any of the above-described embodiments. Rather, the scope of this Disclosure should be defined in accordance with the following claims and their equivalents.

Although disclosed embodiments have been illustrated and described with respect to one or more implementations, equivalent alterations and modifications will occur to others skilled in the art upon the reading and understanding of this specification and the annexed drawings. While a particular feature may have been disclosed with respect to only one of several implementations, such a feature may be combined with one or more other features of the other implementations as may be desired and advantageous for any given or particular application.

The terminology used herein is for the purpose of describing particular embodiments only and is not intended to be limiting to this Disclosure. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.”

We claim:

1. An automatic protection system for receiver circuitry, comprising:
a waveguide switch including a permanent magnet attached to a rotatable manifold and at least one electromagnet axially surrounding said rotatable manifold;
an automatic actuation circuit coupled to said waveguide switch, said automatic actuation circuit comprising:
a RF power detector for detecting incident RF power around said rotatable manifold and generating a detection signal therefrom;
a controller coupled to receive said detection signal and for generating at least a first control signal based on said detection signal, and
a magnet current driver coupled to receive said first control signal and coupled to said electromagnet, said magnet current driver providing at least a first drive signal responsive to said first control signal that automatically rotates said rotatable manifold into a protected position.

2. The system of claim 1, wherein said system provides an operational position and said protected position, wherein said protected position is triggered wherein when said incident RF power exceeds a predetermined RF power level, and wherein said magnet current driver also provides a second drive signal that automatically rotates said rotatable manifold from said protected position into said operational position when said RF power is reduced so that it no longer exceeds said predetermined RF power level.

3. The system of claim 2, wherein operational position and said protected position are 90 degrees apart from one another on said rotatable manifold.

4. The system of claim 1, wherein said controller comprises a comparator that compares said detection signal and a reference signal or reference level.

5. The system of claim 1, wherein said waveguide switch provides a plurality of ports for providing a switchable connection for a plurality of waveguide channels.

6. The system of claim 1, wherein said at least one electromagnet comprises a first and a second electromagnet.

7. The system of claim 1, wherein said RF power detector comprises a diode.

8. A protected electronic system, comprising:
a waveguide assembly including at least one waveguide channel that includes an antenna side and a receiver side;
at least one antenna for transmitting and receiving RF signals coupled to said antenna side of said waveguide channel;
a waveguide switch comprising a permanent magnet attached to a rotatable manifold and at least one electromagnet axially surrounding said rotatable manifold interposed between said antenna side and said receiver side of said waveguide channel;
receiver circuitry coupled to said receiver side of said waveguide channel switchably coupled by said waveguide switch to said antenna side, and
an automatic protection system for said receiver circuitry, comprising:
said waveguide switch;
an automatic actuation circuit coupled to said waveguide switch, said automatic actuation circuit comprising:
a RF power detector for detecting incident RF power around said rotatable manifold and generating a detection signal therefrom;
a controller coupled to receive said detection signal and for generating at least a first control signal based on said detection signal, and
a magnet current driver coupled to receive said first control signal and coupled to said electromagnet, said magnet current driver providing a first drive signal responsive to said first control signal that automatically rotates said rotatable manifold into a protected position that implements a protected path for protecting said receiver circuitry from said incident RF power.

9. The system of claim 8, wherein said receiver circuitry comprises transceiver circuitry.

10. The system of claim 8, wherein said system also provides an operational position that implements a normal operational path, wherein said protected position is triggered wherein when said incident RF power exceeds a predetermined RF power level, and wherein said magnet current driver also provides a second drive signal that automatically rotates said rotatable manifold from said protected position into said operational position when said RF power is reduced so that it no longer exceeds said predetermined RF power level.

11. The system of claim 10, wherein operational position and said protected position are 90 degrees apart from one another on said rotatable manifold.

12. The system of claim 8, wherein said controller comprises a comparator that compares said detection signal and a reference signal or reference level.

13. The system of claim 8, wherein said waveguide assembly includes a plurality of said waveguide channels and said waveguide switch provides a plurality of ports for providing a switchable connection for each of said plurality of waveguide channels.

14. The system of claim 13, wherein said RF power detector comprises a plurality of said RF power detectors, with one of said plurality of RF power detectors coupled to said antenna side of each said plurality of waveguide channels.

15. The system of claim 10, wherein said protected path includes an attenuator element that proves attenuation of at least 20 db for providing a protective power reducing bypass mode that allows protected operation for said receiver circuitry.

16. The system of claim 10, wherein said receiver side of said waveguide channel while in said protected position includes a port termination structure.

17. A flying vehicle having protected electronics, comprising:
a vehicle body having an outer surface including a front portion including a tip and a side portion;
a rocket motor within said outer surface for propelling said flying vehicle, and
a protected electronic system within said outer surface, comprising:
a waveguide assembly including at least one waveguide channel that includes an antenna side and a receiver side;
at least one antenna for transmitting and receiving RF signals coupled to said antenna side of said waveguide channel;
a waveguide switch comprising a permanent magnet attached to a rotatable manifold and at least one electromagnet axially surrounding said rotatable manifold interposed between said antenna side and said receiver side of said waveguide channel;
receiver circuitry coupled to said receiver side of said waveguide channel switchably coupled by said waveguide switch to said antenna side, and
an automatic waveguide-based electronic protection system, comprising:
said waveguide switch;
an automatic actuation circuit coupled to said waveguide switch, said automatic actuation circuit comprising:
a RF power detector for detecting incident RF power around said rotatable manifold and generating a detection signal therefrom;
a controller coupled to receive said detection signal and for generating at least a first control signal based on said detection signal, and
a magnet current driver coupled to receive said first control signal and coupled to said electromagnet, said magnet current driver providing a first drive signal responsive to said first control signal that automatically rotates said rotatable manifold into a protected position that implements a protected path for protecting said receiver electronics from said incident RF power.

18. The vehicle of claim 17, wherein said receiver circuitry comprises RF seeker transceiver electronics and said flying vehicle comprises a missile seeker including an RF seeker, wherein said RF seeker includes said having RF seeker transceiver electronics.

19. The vehicle of claim 17, wherein said system also provides an operational position that implements a normal operational path, wherein said protected position is triggered wherein when said incident RF power exceeds a predetermined RF power level, and wherein said magnet current driver also provides a second drive signal that automatically rotates said rotatable manifold from said protected position into said operational position when said RF power is reduced so that it no longer exceeds said predetermined RF power level.

20. The vehicle of claim 17, wherein said waveguide assembly includes a plurality of said waveguide channels and said waveguide switch provides a plurality of ports for providing a switchable connection for each of said plurality of waveguide channels, wherein said RF power detector comprises a plurality of said RF power detectors, with one of said plurality of RF power detectors coupled to said antenna side of each said plurality of waveguide channels.
